(19) United States
(12) Patent Application Publication
(10) Pub. No.: US 2017/0002442 A1
(43) Pub. Date: Jan. 5, 2017

(54) HYDROGEN-ABSORBING ALLOY, ALLOY POWDER FOR ELECTRODE, NEGATIVE ELECTRODE FOR ALKALINE STORAGE BATTERY, AND ALKALINE STORAGE BATTERY

(71) Applicant: PANASONIC INTELLECTUAL PROPERTY MANAGEMENT CO., LTD., Osaka-shi (JP)

(72) Inventors: HIDEAKI OHYAMA, Osaka (JP); AKIKO OKABE, Osaka (JP); FUMIO KATO, Osaka (JP)

(21) Appl. No.: 15/115,240

(22) PCT Filed: Feb. 12, 2015
(86) PCT No.: PCT/JP2015/000623

§ 371 Date: Jul. 28, 2016

(30) Foreign Application Priority Data
Mar. 12, 2014 (JP) 2014-048668

(51) Int. Cl. C22C 19/00; H01M 4/30; H01M 4/04; H01M 4/66; C22C 1/02; C22C 19/03; B22F 1/00; B22F 9/04; B22D 7/00; C22F 1/10; H01M 4/24; H01M 10/28

(52) U.S. Cl. CPC C22C 19/007; H01M 4/242; H01M 4/30; H01M 4/0404; H01M 4/043; H01M 4/0471; H01M 4/662; H01M 10/283; H01M 10/286; C22C 19/03; B22F 1/0003; B22F 9/04; B22D 7/005; C22F 1/10; C22C 1/023; H01M 2004/027

(57) ABSTRACT

A hydrogen-absorbing alloy is provided in which an X-ray diffraction image generated by CuKα rays has at least one peak selected from (1) peak Psp1 at 2θ=32.25±0.15°, (2) peak Psp2 at 2θ=33.55±0.15°, and (3) peak Psp3 at 2θ=37.27±0.15°.

### TECHNICAL FIELD

The present invention relates to a hydrogen-absorbing alloy having a new crystal structure, alloy powder for an electrode, a negative electrode for an alkaline storage battery, and an alkaline storage battery.

### BACKGROUND ART

A hydrogen-absorbing alloy having a crystal structure of the Ce₂Ni₇ type and CeNi₃ type is known to have a relatively high capacity, and is expected as alloy powder for an electrode. However, in the case that a conventional hydrogen-absorbing alloy having a relatively high capacity is used as alloy powder for an electrode of an alkaline storage battery, it is known that repeating a charge/discharge cycle of the alkaline storage battery decreases the discharge capacity in a relatively early stage.

While, it is reported that, in a hydrogen-absorbing alloy having a basic unit (cell) of the A₂B₄ type and AB₅ type, the deterioration of the alloy due to the absorption and desorption of hydrogen is suppressed (Patent Literature 1).

Furthermore, it is also reported that a hydrogen-absorbing alloy having, as a main phase, an A₂B₇ type or AB₃ type crystal phase, or its similar crystal phase, and having an AB₃ type, A₂B₇ type, and/or A₅B₁₉ type parallel growth has a high capacity and a high life property (Patent Literature 2).

Furthermore, it is also reported that the following alkaline storage battery has a high hydrogen-absorbing capability, a high low-temperature discharge characteristic, and a high-rate discharge characteristic (Patent Literature 3). The alkaline storage battery employs a hydrogen-absorbing alloy that includes a rare-earth element (including Gd), Mg, Ni, and Al, and has a crystal structure other than the AB₅ type crystal structure.

### CITATION LIST

### Patent Literature

PTL 1: Unexamined Japanese Patent Publication No. 2012-174639

PTL 2: International Patent Publication No. 2001-48841 brochure

PTL 3: Unexamined Japanese Patent Publication No. 2006-277995

### SUMMARY OF THE INVENTION

### Technical Problem(s)

In conventional hydrogen-absorbing alloys as disclosed in Patent Literatures 1 to 3, the improvement of the life property of an alkaline storage battery is limited. Therefore, a hydrogen-absorbing alloy capable of achieving an alkaline storage battery having a high capacity and a long life is demanded to be developed.

### Solution(s) to Problem(s)

One aspect of the present invention relates to a hydrogen-absorbing alloy in which an X-ray diffraction image generated by CuKα rays has at least one peak selected from (1) peak Psp1 at 2θ=32.25±0.15°, (2) peak Psp2 at 2θ=33.55±0.15°, and (3) peak Psp3 at 2θ=37.27±0.15°.

Another aspect of the present invention relates to alloy powder for an electrode including the hydrogen-absorbing alloy.

Yet another aspect of the present invention relates to a negative electrode for an alkaline storage battery. The negative electrode includes the alloy powder for the electrode as a negative electrode active material.

Still another aspect of the present invention relates to an alkaline storage battery that includes a positive electrode, a negative electrode, a separator interposed between the positive electrode and negative electrode, and an alkaline electrolytic solution. The negative electrode is the negative electrode for the alkaline storage battery.

### Advantageous Effect(s) of Invention

The present invention can achieve an alkaline storage battery having a high capacity and a long life.

### BRIEF DESCRIPTION OF DRAWINGS

FIG. 1 is a vertical sectional view schematically showing the structure of an alkaline storage battery in accordance with an exemplary embodiment of the present invention.

FIG. 2 is a diagram showing X-ray diffraction images of hydrogen-absorbing alloys.

### DESCRIPTION OF EMBODIMENT(S)

(Hydrogen-Absorbing Alloy)

An X-ray diffraction image generated by CuKα rays in a hydrogen-absorbing alloy of the present exemplary embodiment has at least one peak selected from (1) peak Psp1 at 2θ=32.25±0.15° (namely, 32.10 to 32.40°), (2) peak Psp2 at 2θ=33.55±0.15° (namely, 33.40 to 33.70°), and (3) peak Psp3 at 2θ=37.27±0.15° (namely, 37.12 to 37.42°). None of peak Psp1, peak Psp2, and peak Psp3 is observed in an X-ray diffraction image in the conventional hydrogen-absorbing alloy. In other words, it is considered that the hydrogen-absorbing alloy of the present invention includes a new crystal region (hereinafter, crystal phase Psp).

The hydrogen-absorbing alloy of the present exemplary embodiment has a crystal structure belonging to a space group of P63/mmc, for example. As an alloy having a crystal structure belonging to the space group of P63/mmc, for example, an A₂B₇ type (AB_{3.5} type) alloy and an A₅B₁₉ type (AB_{3.8} type) alloy are known. These alloys have a capacity higher than that of an AB₅ type alloy, but their crystal structures are relatively unstable. As discussed above, in the X-ray diffraction images of the A₂B₇ type alloy and an A₅B₁₉ type alloy, none of peak Psp1, peak Psp2, and peak Psp3 is observed.

Although the details are unclear, crystal phase Psp that raises at least one peak selected from peak Psp1, peak Psp2, and peak Psp3 is considered to have an intermediate structure between the A₂B₇ type and A₅B₁₉ type. In a basic unit (cell), the length of crystal phase Psp in the c-axis direction is longer than 24 angstroms and shorter than 32 angstroms.

The hydrogen-absorbing alloy having crystal phase Psp has a capacity higher than that of the AB₅ type alloy or the like. Although the reason is not clear, in the case that the hydrogen-absorbing alloy having crystal phase Psp is used as alloy powder for an electrode of an alkaline storage battery, the decrease of the discharge capacity when a charge/discharge cycle of the alkaline storage battery is repeated is supplied. Thus, the hydrogen-absorbing alloy having crystal phase Psp is useful for the alloy powder for the electrode.

In the X-ray diffraction image of the hydrogen-absorbing alloy having crystal phase Psp, a plurality of specific peaks Psp(k) can be observed in association with the rising of peak Psp1, peak Psp2, and/or peak Psp3. Peaks Psp(k) are observed in the following regions, for example.
Peak Psp(4): 2θ=10.6 to 11.2°
Peak Psp(5): 2θ=12.8 to 13.4°
Peak Psp(6): 2θ=26.1 to 26.7°
Peak Psp(7): 2θ=26.6 to 27.2°
Peak Psp(8): 2θ=28.2 to 28.8°
Peak Psp(9): 2θ=30.2 to 30.6°
Peak Psp(10): 2θ=31.5 to 31.8°

In the present exemplary embodiment, the intensity of peak Psp1 is not particularly limited. However, when the ratio (I1/Imax) of intensity I1 of peak Psp1 to intensity Imax of maximum peak Pmax of the X-ray diffraction image in the range of 2θ=10 to 90° is 0.01 or more, crystal phase Psp is considered to grow sufficiently. Similarly, the intensity of peak Psp2 is not particularly limited either. However, also when the ratio (I2/Imax) of intensity 12 of peak Psp2 to intensity Imax of maximum peak Pmax of the X-ray diffraction image in the range of 2θ=10 to 90° is 0.01 or more, crystal phase Psp is considered to grow sufficiently. Furthermore, the intensity of peak Psp3 is not particularly limited either. However, also when the ratio (I3/Imax) of intensity 13 of peak Psp3 to intensity Imax of maximum peak Pmax of the X-ray diffraction image in the range of 2θ=10 to 90° is 0.01 or more, crystal phase Psp is considered to grow sufficiently. More preferably, ratio Il/Imax is 0.04 or more, ratio I2/Imax is 0.09 or more, and ratio I3/Imax is 0.05 or more,

The composition of the hydrogen-absorbing alloy having crystal phase Psp is not particularly limited, but it is preferable that the composition includes element L, element M, and element E, for example.

Here, element L is at least one element selected from a set consisting of the elements in group 3 and the elements in group 4 on the periodic table. Element M is an alkaline-earth metal element. Element E is at least one element selected from a set consisting of: the transition metal elements in groups 5 to 11 on the periodic table; the elements in group 12; the elements in group 13 periods 2 to 5; elements in group 14 periods 3 to 5; N; P; and S. In an ABx type hydrogen-absorbing alloy, element L and element M exist in site A, and element E exists mainly in site B.

Molar ratio mE of element E to the total of element L and element M preferably satisfies 2.5≦mE≦4.5, more preferably satisfies 2.7≦mE≦3.3. Thanks to such a composition, a crystal structure belonging to the space group of P63/mmc is easily produced.

Molar ratio x of element M to the total of element L and element M preferably satisfies 0.28≦x≦0.5, more preferably satisfies 0.3x≦0.4. Thanks to such a composition, a crystal structure belonging to the space group of P63/mmc is easily produced.

Regarding element L, the elements in group 3 on the periodic table include Sc, Y, lanthanoid elements, and actinoid elements. The lanthanoid elements include La, Ce, Pr, Nd, Pm, Sm, Eu, Gd, Tb, Dy, Ho, Er, Tm, Yb, and Lu. The actinoid elements include Ac, Th, Pa, and Np, for example. Regarding element L, the elements in group 4 on the periodic table include Ti, Zr, and HE Element L may include one of the above-mentioned elements, or may include two or more thereof.

Preferably, element L includes at least Y and lanthanoid elements, of the above-mentioned elements. Y has a high oxygen affinity, and has a capability of reducing surrounding oxides. Therefore, when element L includes Y, corrosion of the hydrogen-absorbing alloy is suppressed. Molar ratio y of Y to element L preferably satisfies 0.001≦y≦0.1, more preferably satisfies 0.01≦y≦0.5. Of the lanthanoid elements, La, Ce, Pr, Nd, and Sm are preferable, La and Sm are more preferable, and La is the most preferable. Molar ratio z of La to element L preferably satisfies 0.5≦z≦0.9, more preferably satisfies 0.6≦z≦0.7.

Examples of element M, namely an alkaline-earth metal element, include Mg, Ca, Sr, and Ba. The alkaline-earth metal element is apt to produce a hydride having an ion binding property, so that a hydrogen-absorbing alloy including element M is considered to contribute to a high capacity. Element M may include one of the alkaline-earth metal elements, or may include two or more thereof.

Preferably, element M includes at least Mg. Molar ratio v of Mg to element M is preferably satisfies 0.001≦v≦1, more preferably satisfies 0.3≦v≦1. Thus, the alloy is apt to absorb hydrogen, can increase the capacity, and suppresses the reduction in desorption of hydrogen.

Element E is at least one element selected from a set consisting of: the transition metal elements in groups 5 to 11 on the periodic table; the elements in group 12; the elements in group 13 periods 2 to 5; the elements in group 14 periods 3 to 5; N; P; and S. Element E may include one of the above-mentioned elements, or may include two or more thereof. Especially, preferably, element E includes at least one element selected from a set consisting of V, Nb, Ta, Cr, Mo, W, Mn, Fe, Co, Ni, Cu, Ag, Zn, B, Al, Ga, In, Si, Ge, Sn, and P. Particularly preferably, element E includes at least Ni, Co, and At

Ni is preferable as a main component of element E. Molar ratio mNi of Ni to the total of element L and element M preferably satisfies 2≦mNi≦3.8, more preferably satisfies 2≦mNi≦3.

Co is strongly bonded to surrounding elements. The generation of crystal defects due to the expansion and contraction of the alloy is considered to be suppressed when hydrogen is absorbed and desorbed. Molar ratio mCo of Co to the total of element L and element M preferably satisfies 0.15≦mCo≦0.5, more preferably satisfies 0.2≦mCo≦0.3.

Al has an effect of reducing the hydrogen equilibrium pressure in a hydrogen absorbing reaction. Molar ratio mAl of Al to the total of element L and element M preferably satisfies 0.01≦mAl≦0.1, more preferably satisfies 0.01≦mAl≦0.07.

When element E includes Cu, the crystal distortion caused by the expansion and contraction due to the repetition of charge and discharge is further reduced. Molar ratio mCu of Cu to the total of element L and element M preferably satisfies 0≦mCu≦0.03, more preferably satisfies 0.001≦mCu≦0.02.

When element E further includes elements such as Ge and Sn, the activity of the alloy surface can be enhanced, and the elution of the constituent elements can be suppressed. Ge is apt to produce complex hydroxide, so that the deterioration of the alloy is suppressed. Sn has a capability of suppressing the expansion and contraction when hydrogen is absorbed and desorbed. Molar ratio mGe of Ge to the total of element L and element M preferably satisfies 0≦mGe≦0.1, more preferably satisfies 0.001≦mGe≦0.1. Molar ratio mSn of Sn to the total of element L and element M preferably satisfies 0≦mSn≦0.1, more preferably satisfies 0.001≦mSn≦0.1.

When element E further includes a small amount of N, the mobility in solid of hydrogen is apt to increase. This increase is estimated to be caused by the phenomenon that a hydrogen travel path from N is formed in a hydrogen-absorbing alloy crystal. Increasing the diffusion coefficient in solid of hydrogen improves the discharge characteristic (especially, discharge characteristic at low temperature). Molar ratio mN of N to the total of element L and element M preferably satisfies 0≦mN≦0.01, more preferably satisfies 0.001≦mN≦0.01.

In the hydrogen-absorbing alloy belonging to the space group of P63/mmc, the crystal structure is complicated and relatively unstable, and the constituent elements of the hydrogen-absorbing alloy are apt to be eluted. While, in a hydrogen-absorbing alloy having crystal phase Psp, it is considered that the elution of the constituent elements can be effectively suppressed.

Hereinafter, a manufacturing method of a hydrogen-absorbing alloy having crystal phase Psp and alloy powder for an electrode is described. The alloy powder for the electrode can be produced through the following processes:

(i) process A of producing an alloy from the simple substances of the constituent elements of the hydrogen-absorbing alloy;

(ii) process B of granulating the alloy obtained in process A; and

(iii) process C of activating the granulated substance obtained in process B.

(i) Process A (Alloying Process)

As the alloying process, a plasma arc melting method, a high frequency melting method (metal mold casting method), a mechanical alloying method (machine alloy method), a mechanical milling method, and a rapid solidification method are known. The rapid solidification method includes a roll spinning method, a melt drag method, a direct casting and rolling method, a rotating liquid spinning method, a spray forming method, a gas atomizing method, a wet spraying method, a splat method, a rapid-solidification thin strip grinding method, a gas atomization splat method, a melt extraction method, and a rotating electrode method. In order to produce a hydrogen-absorbing alloy having crystal phase Psp, the following method is appropriate, for example.

First, simple substances of the constituent elements are prepared. A method of previously mixing the simple substances and alloying the obtained mixture using the above-mentioned methods can be employed. In order to produce a hydrogen-absorbing alloy having crystal phase Psp, however, it is preferable to melt the simple substances of the constituent elements in the descending sequence of the melting point. Specifically, the simple substance of the element with a maximum melting point, of the constituent elements, is molten first, and the simple substance of the element with the next-higher melting point is injected into the molten metal. Subsequently, substances are injected into the molten metal in the descending sequence of the melting point, and all of the constituent elements are molten. Here, elements whose melting points are different from each other by 100° C. or less may be simultaneously molten. Preferably, the temperature of the molten metal is gradually decreased in response to the melting point of the injected element. Such an operation promotes the production of a hydrogen-absorbing alloy having crystal phase Psp. Although the reason is not clear, the suppression of the evaporation of an element with a low melting point is considered to relate to the generation of crystal phase Psp, for example. When a part of the constituent elements is an alkaline-earth metal element (element M), the above-mentioned method is particularly effective.

Next, after all the constituent elements are molten, the molten metal is cooled to produce a crude alloy. For example, a crude alloy is obtained by supplying the molten metal to a mold or the like and cooling it in the mold. Then, preferably, the crude alloy is annealed. By annealing it, the dispersibility of the constituent elements in the hydrogen-absorbing alloy is improved, and the elution and segregation of the constituent elements are easily suppressed. In the annealing, the crude alloy is preferably heated to 900° C. to 1100° C., more preferably heated to 950° C. to 1050° C. The heating duration is 4 to 48 hours, for example.

Preferably, the crude alloy is annealed in a pressurized atmosphere containing inert gas such as argon. The pressure of the pressurized atmosphere is 0.15 to 1 MPa, for example. Such annealing further promotes the generation of crystal phase Psp. Although the reason is not clear, the suppression of the evaporation of an element with a low melting point is also considered to relate to the generation of crystal phase Psp, for example. Thus, an ingot of the hydrogen-absorbing alloy with crystal phase Psp is obtained.

(ii) Process B (Granulating Process)

In process B, the ingot of the alloy obtained in process A is granulated. The granulation of the alloy can be performed by wet crushing or dry crushing, or these methods may be combined together. The crushing can be performed using a ball mill or the like. In the wet crushing, the ingot is crushed using a liquid medium such as water. Obtained particles are classified if necessary.

The mean particle size of the obtained alloy particles is 5 to 50 μm for example, preferably 5 to 30 μm. When the mean particle size is within such a range, the surface area of the hydrogen-absorbing alloy can be kept in an appropriate range. In the present description, the mean particle size means the volume basis median diameter.

The alloy particles obtained in process B are sometimes referred to as raw powder of the alloy powder for the electrode.

(iii) Process C (Activating Process)

In process C, a crushed product (raw powder) can be activated by bringing the crushed product into contact with an alkaline aqueous solution. The method of bringing the raw powder into contact with the alkaline aqueous solution is not particularly limited. For example, the raw powder is immersed in the alkaline aqueous solution, the raw powder is added to the alkaline aqueous solution and they are stirred, or the alkaline aqueous solution is sprayed to the raw powder. The activation may be performed in the heating state.

Examples of the alkaline aqueous solution can include aqueous solutions containing potassium hydroxide, sodium hydroxide, and lithium hydroxide. Among them, preferably, sodium hydroxide and/or potassium hydroxide are used. From the viewpoint of the efficiency of activation, the productivity, and the reproducibility of a process, the alkali concentration in the alkaline aqueous solution is 5 to 50 mass % for example, preferably 10 to 45 mass %.

After the activation treatment by the alkaline aqueous solution, the obtained alloy powder may be washed with water. In order to reduce the remaining of impurities on the surface of the alloy powder, preferably, the wash with water is finished after the pH of the water used for the wash becomes 9 or less. The alloy powder after the activation treatment is normally dried.

The alloy powder for the electrode of the present invention can be obtained through these processes, and a high capacity and a life property can be reconciled with each other. Therefore, the alloy powder is appropriate for use as a negative electrode active material of an alkaline storage battery.

(Alkaline Storage Battery)

An alkaline storage battery includes a positive electrode, a negative electrode, a separator interposed between the positive electrode and negative electrode, and an alkaline electrolytic solution. The negative electrode includes the above-mentioned alloy powder for the electrode as the negative electrode active material.

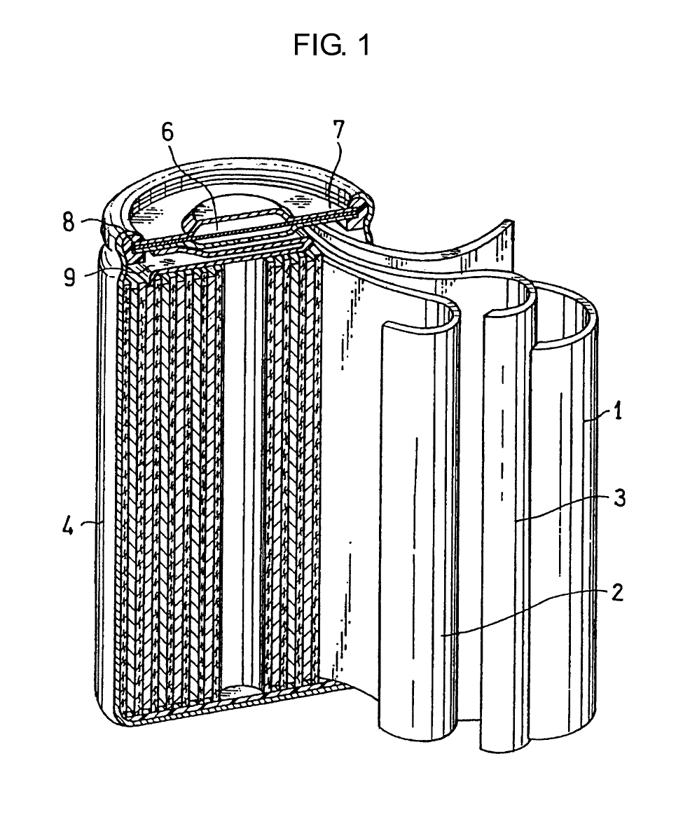

The configuration of the alkaline storage battery is described hereinafter with reference to FIG. 1. FIG. 1 is a vertical sectional view schematically showing the structure of an alkaline storage battery in accordance with an exemplary embodiment of the present invention. The alkaline storage battery includes a bottomed cylindrical battery case 4 serving also as a negative electrode terminal, an electrode group stored in battery case 4, and an alkaline electrolytic solution (not shown). In the electrode group, negative electrode 1, positive electrode 2, and separator 3 interposed between them are wound spirally. Seal plate 7 having safety valve 6 is disposed in an opening in battery case 4 via insulating gasket 8. By caulking the opening end of battery case 4 inward, the alkaline storage battery is sealed. Seal plate 7 serves also as a positive electrode terminal, and is electrically connected to positive electrode 2 via positive electrode lead 9.

Such an alkaline storage battery can be obtained by storing the electrode group in battery case 4, injecting the alkaline electrolytic solution, placing seal plate 7 in the opening in battery case 4 via insulating gasket 8, and caulking and sealing the opening end of battery case 4. At this time, negative electrode 1 of the electrode group is electrically connected to battery case 4 via a negative-electrode current collector disposed between the electrode group and the inner bottom of battery case 4. Positive electrode 2 of the electrode group is electrically connected to seal plate 7 via positive electrode lead 9.

Next, the components of a nickel-metal-hydride storage battery are more specifically described.

(Negative Electrode)

The negative electrode is not particularly limited as long as it includes the above-mentioned alloy powder for the electrode as the negative electrode active material. As another component, a known component used in a nickel-metal-hydride storage battery can be employed.

The negative electrode may include a core member, and a negative electrode active material adhering to the core member. Such a negative electrode can be formed by applying a negative electrode paste including at least a negative electrode active material (alloy powder for an electrode) to the core member. As the negative electrode core member, a known member can be employed. The negative electrode core member can be exemplified by a porous or imperforate substrate made of a stainless steel, nickel, or an alloy of them. When the core member is a porous substrate, an active material may be filled in a hole of the core member.

The negative electrode paste normally includes a dispersion medium. If necessary, a known component used for the negative electrode—for example, a conductive agent, binder, or thickener—may be added to the paste. The negative electrode, for example, can be formed by applying the negative electrode paste to the core member, then removing the dispersion medium through drying, and rolling them. As the dispersion medium, a known medium such as water can be employed.

The conductive agent is not particularly limited as long as it is a electron-conductive material. Examples of the conductive agent include: graphite such as natural graphite (flake graphite or the like), artificial graphite, or expanded graphite; carbon black such as acetylene black or ketjen black; conductive fiber such as carbon fiber or metal fiber; metal particles such as copper powder; and an organic conductive material such as a polyphenylene derivative. These conductive agents can be used singly or as a combination of two or more. The amount of the conductive agent is, to 100 pts·mass of alloy powder for an electrode, 0.01 to 50 pts·mass for example, preferably 0.1 to 30 pts·mass.

The binder is made of a resin material. Examples of the binder include: a rubber material such as styrene-butadiene copolymer rubber (SBR); a polyolefin resin such as polyethylene or polypropylene; a fluorine resin such as polytetrafluoroethylene, polyvinylidene fluoride, tetrafluoroethylene-hexafluoropropylene copolymer, or tetrafluoroethylene-perfluoroalkylvinylether copolymer; and an acrylic resin such as an ethylene-acrylic acid copolymer, ethylene-methacrylic acid copolymer, ethylene-methyl acrylate copolymer, and its Na ion crosslinked polymer. These binders can be used singly or as a combination of two or more. The amount of the binder is, to 100 pts·mass of alloy powder for an electrode, 0.01 to 10 pts·mass for example, preferably 0.05 to 5 pts·mass.

Examples of the thickener include: a cellulose derivative such as carboxymethyl cellulose (CMC), modified CMC (including salt such as Na salt), or methyl cellulose; a saponified substance of a polymer having a vinyl acetate unit such as polyvinyl alcohol; and polyalkylene oxide such as polyethylene oxide. These thickeners can be used singly or as a combination of two or more. The amount of the thickener is, to 100 pts·mass of alloy powder for an electrode, 0.01 to 10 pts·mass for example, preferably 0.05 to 5 pts·mass.

(Positive Electrode)

The positive electrode may include a core member, and an active material or an active material layer adhering to the core member. The positive electrode can be formed by applying a positive electrode paste that includes at least a positive electrode active material to the core member. More specifically, the positive electrode can be formed by applying the positive electrode paste to the core member, then removing the dispersion medium through drying, and rolling them. The positive electrode may be an electrode formed by sintering active material powder together with the core member.

As the positive electrode core member, a known member can be employed. The positive electrode core member can be exemplified by a porous substrate made of a nickel foam or a sintered nickel plate. As the positive electrode active material, for example, a nickel compound such as nickel hydroxide or nickel oxyhydroxide is employed.

The positive electrode paste normally includes a dispersion medium. If necessary, a known component used for the positive electrode—for example, a conductive agent, binder, or thickener—may be added to the paste. The dispersion medium, the conductive agent, the binder, the thickener, and their amounts can be selected similarly to the case of the negative electrode paste.

As the conductive agent, conductive cobalt oxide such as cobalt hydroxide or cobalt γ-oxyhydroxide may be employed. The positive electrode may include, as an additive, a metal compound (oxide or hydroxide) such as zinc oxide or zinc hydroxide.

(The Others)

As the separator, a microporous film or non-woven fabric made of polyolefin such as polyethylene or polypropylene can be employed.

As the alkaline electrolytic solution, for example, an aqueous solution containing an alkaline electrolyte is employed. As an example of the alkaline electrolyte, alkali metal hydroxide such as lithium hydroxide, potassium hydroxide, or sodium hydroxide can be employed. These compounds can be used singly or as a combination of two or more. The alkaline electrolytic solution preferably includes at least potassium hydroxide, and more preferably includes sodium hydroxide and/or lithium hydroxide in addition. The specific gravity of the alkaline electrolytic solution is 1.03 to 1.55 for example, preferably 1.11 to 1.32.

Hereinafter, the present invention is specifically described on the basis of examples and a comparative example. The present invention is not limited to the following examples.

### EXAMPLE 1

(1) Preparation of Raw Powder

The simple substances of La (melting point of 920° C.) and Y (melting point of 1526° C.) as element L, Mg (melting point of 650° C.) as element M, and Co (melting point of 1495° C.), Al (melting point of 660° C.), and Ni (melting point of 1455° C.) as element E are molten at the mass ratios or molar ratios shown in Table 1 in a high-frequency melting furnace. At this time, the substances are injected into the high-frequency melting furnace in the descending sequence (Y>Co>Ni>La>Al>Mg) of the melting point. After an injected substance is sufficiently molten, the next substance is injected. However, Y, Co, and Ni are simultaneously injected into the high-frequency melting furnace of 1550° C. Then, the temperature of the high-frequency melting furnace is decreased to 1200° C., and then La is injected into the molten metal. Then, the temperature of the high-frequency melting furnace is decreased to 1100° C., and then Al and Mg are injected into the molten metal. The molten metal is poured into a mold, and an ingot of a hydrogen-absorbing alloy is produced.

The obtained ingot is heated and annealed for 10 hours under atmospheric pressure, under an argon atmosphere, and at 1060° C. The annealed ingot is crushed into particles. The obtained particles are crushed in the presence of water using a wet ball mill, and are passed through a sieve of a mesh size of 75 μm in a wet state. Thus, a hydrogen-absorbing alloy (raw powder) of a mean particle size of 20 μm is obtained.

(2) Preparation of Alloy Powder for an Electrode

The raw powder obtained in process (1) is mixed with an alkaline aqueous solution of a temperature of 100° C. that contains sodium hydroxide at a concentration of 40 mass %, and they are continuously stirred for 50 minutes. The obtained powder is collected, washed with hot water, dehydrated, and then dried. The washing is continued until the pH of the hot water after use becomes 9 or less. As a result, alloy powder for an electrode from which impurities have been removed is obtained.

(3) Production of Negative Electrode

To 100 pts·mass of alloy powder for an electrode (obtained in process (2)), 0.15 pts·mass of CMC, 0.3 pts·mass of acetylene black, and 0.7 pts·mass of SBR are added, and further water is added. They are kneaded to prepare a negative electrode paste. The obtained negative electrode paste is applied to both surfaces of a core member that is made of an iron punching metal plated with nickel (thickness of 60 μm, hole diameter of 1 mm, an open area percentage of 42%). The applied paste is dried, and then pressed together with the core member by a roller. Thus, a negative electrode of a capacity of 2200 mAh is obtained. An exposed portion of the core member is disposed at one end of the negative electrode along the longitudinal direction.

(4) Production of Positive Electrode

A sintered positive electrode of a capacity of 1500 mAh is obtained by filling nickel hydroxide into a positive electrode core member made of a porous sintered substrate. As the positive electrode active material, about 90 pts·mass of Ni(OH)₂ is employed. To the positive electrode active material, about 6 pts·mass of Zn(OH)₂ is added as an additive, and about 4 pts·mass of Co(OH)₂ is added as a conductive material. An exposed portion of the core member having no active material is disposed at one end of the positive electrode core member along the longitudinal direction.

(5) Production of Nickel-Metal-Hydride Storage Battery

A nickel-metal-hydride storage battery of 4/5A size with a nominal capacity of 1500 mAh shown in FIG. 1 is produced using the negative electrode and positive electrode obtained in the above-mentioned method. Specifically, positive electrode 2 and negative electrode 1 are wound via separator 3 to produce a cylindrical electrode group. In the electrode group, the exposed portion of the positive electrode core member and the exposed portion of the negative electrode core member are exposed on the opposite end surfaces. As separator 3, non-woven fabric (thickness of 100 μm) made of sulfonated polypropylene is employed. Positive electrode lead 9 is welded to the end surface of the electrode group on which the positive electrode core member is exposed. A negative electrode current collector is welded to the end surface of the electrode group on which the negative electrode core member is exposed.

Seal plate 7 is electrically connected to positive electrode 2 via positive electrode lead 9. Then, the electrode group is stored in battery case 4 formed of a cylindrical bottomed-can so that the negative electrode current collector is disposed on the downside. The negative electrode lead connected to the negative electrode current collector is welded to the bottom of battery case 4. The electrolytic solution is injected into battery case 4, and then the opening of battery case 4 is sealed with seal plate 7 having gasket 8 on its periphery. Thus, the nickel-metal-hydride storage battery is completed.

As the electrolytic solution, an alkaline aqueous solution obtained by dissolving lithium hydroxide in a potassium hydroxide aqueous solution (specific gravity:1.3) in a proportion of 40 g/L is employed.

### EXAMPLE 2

In the producing process of raw powder, a hydrogen-absorbing alloy of a mean particle size of 20 μm is obtained similarly to the process of example 1 with the following exceptions:

the simple substances of La, Y, Mg, Co, Al, and Ni are used at the mass ratios or molar ratios shown in Table 1; and

the obtained ingot is heated and annealed for 10 hours at 1060° C. under an argon atmosphere of a pressure of 0.3 MPa.

Furthermore, a negative electrode and a nickel-metal-hydride storage battery are produced similarly to the method of example 1.

### EXAMPLE 3

In the producing process of raw powder, a hydrogen-absorbing alloy of a mean particle size of 20 μm is obtained similarly to the process of example 1 with the following exceptions:

the simple substance of Cu (melting point of 1084° C.), in addition to La, Y, Mg, Co, Al, and Ni, is used at the mass ratio or molar ratio shown in Table 1; and the obtained ingot is heated and annealed for 10 hours at 1060° C. under an argon atmosphere of a pressure of 0.3 MPa.

Here, Cu is injected into the molten metal after Y, Co, and Ni are injected into the high-frequency melting furnace and before La is injected. Furthermore, a negative electrode and a nickel-metal-hydride storage battery are produced similarly to the method of example 1.

### COMPARATIVE EXAMPLE 1

In the producing process of raw powder, raw powder including a hydrogen-absorbing alloy of a mean particle size of 20 μm is obtained similarly to the process of example 1 with the following exception:

the simple substances of La, Y, Mg, Co, Al, and Ni are simultaneously molten in the high-frequency melting furnace of 1500° C. at the mass ratios or molar ratios shown in Table 1

TABLE 1

| | | La | Mg | Co | Al | Ni | Y | Cu |
|---|---|---|---|---|---|---|---|---|
| Comparative | mass % | 32.94 | 1.9 | 5 | 0.45 | 59.4 | 0.31 | 0 |
| example 1 | molar ratio | 0.752 | 0.248 | 0.270 | 0.053 | 3.21 | 0.0111 | 0 |
| Example 1 | mass % | 33.03 | 2.6 | 4.9 | 0.47 | 58.7 | 0.3 | 0 |
| | molar ratio | 0.690 | 0.310 | 0.241 | 0.0504 | 2.90 | 0.0098 | 0 |
| Example 2 | mass % | 32.5 | 2.8 | 4.9 | 0.5 | 59 | 0.3 | 0 |
| | molar ratio | 0.670 | 0.330 | 0.238 | 0.0530 | 2.88 | 0.0097 | 0 |
| Example 3 | mass % | 32.5 | 2.8 | 4.9 | 0.51 | 58.8 | 0.28 | 0.21 |
| | molar ratio | 0.67 | 0.330 | 0.238 | 0.0541 | 2.87 | 0.0090 | 0.0095 |

The electrode alloy powder and nickel-metal-hydride storage battery obtained in each of the examples and comparative example are evaluated as below.

(a) X-Ray Diffraction Measurement

X-ray diffraction measurement of the electrode alloy powder is performed with CuKα rays in the following conditions:
measuring device is X′Pert PRO manufactured by Spectris Co., Ltd.;
target is monochrome Cu/C;
tube voltage and tube current are 45 kV and 40 mA;
scan mode is Continuous;
step width is 0.02°;
scan speed is 120 s/step;
slit width (DS/SS/RS) is 0.5°/None/0.1 mm; and
measuring range is 10 to 90° (2η).

Each of the X-ray diffraction images of examples 1 to 3 is verified to have the crystal structure described below. The crystal structure has specific peak Psp1, peak Psp2, and peak Psp3 at (1) 2θ=32.25±0.15°, (2) 2θ=33.55±0.15°, and (3) 2θ=37.27±0.15°, respectively, has crystal phase Psp, and belongs to the space group of P63/mmc.

In examples 1 to 3, the ratio (I1/Imax) of intensity I1 (number of counts (ₚₑₐk height), same as above) of peak Psp1 to intensity Imax of maximum peak Pmax in the range of 2θ=10 to 90° is 0.01 or more. The ratio (I2/Imax) of intensity I2 of peak Psp2 to intensity Imax of maximum peak Pmax is 0.01 or more. Furthermore, the ratio (I3/Imax) of intensity I3 of peak Psp3 to intensity Imax of maximum peak Pmax is also 0.01 or more.

Maximum peak Pmax is observed at 2θ=42.21°.

While, in comparative example 1, a clear peak is observed in none of the regions: (1) 2θ=32.25±0.15°, (2) 2θ=33.55±0.15°, and (3) 2θ=37.27±0.15°. The alloy of comparative example 1 is verified to be the A₂B₇ type.

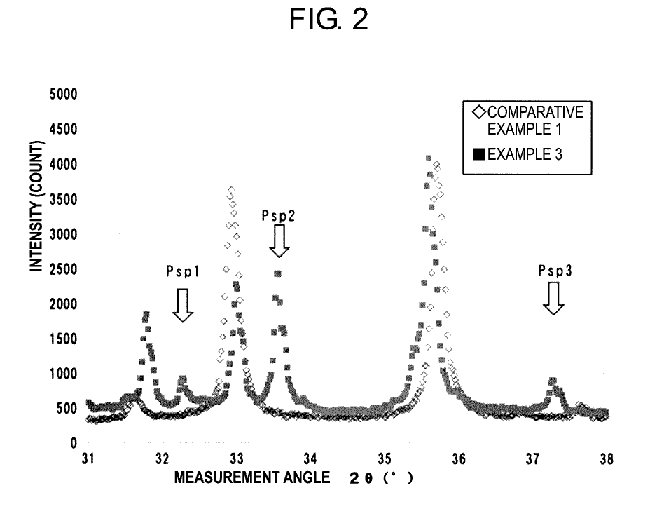

FIG. 2 shows X-ray diffraction images in example 3 and comparative example 1. Table 2 shows positions (2θ) of peaks Psp1, Psp2, and Psp3 observed in the X-ray diffraction images in the examples and the comparative example, and the intensity ratios (ratios in number of counts) to intensity Imax of maximum peak Pmax.

TABLE 2

| peak | 2θ (°) | Example 1 | Example 2 | Example 3 |
|---|---|---|---|---|
| Psp(4) | 10.89 | 0.08 | 0.06 | 0.07 |
| Psp(5) | 13.11 | 0.06 | 0.07 | 0.08 |
| Psp(6) | 26.41 | 0.04 | 0.04 | 0.05 |
| Psp(7) | 26.92 | 0.05 | 0.05 | 0.06 |
| Psp(8) | 28.47 | 0.05 | 0.07 | 0.07 |
| Psp(9) | 30.91 | 0.05 | 0.06 | 0.06 |
| Psp(10) | 31.79 | 0.08 | 0.16 | 0.16 |
| Psp1 | 32.25 | I1/Imax: 0.05 | I1/Imax: 0.04 | I1/Imax: 0.08 |
| Psp2 | 33.52 | I2/Imax: 0.11 | I2/Imax: 0.20 | I2/Imax: 0.21 |
| Psp3 | 37.28 | I3/Imax: 0.05 | I3/Imax: 0.07 | I3/Imax: 0.08 |

(b) High-Temperature Life Property

The nickel-metal-hydride storage batteries in the examples and the comparative example are charged for 15 hours at 10 hour rate (150 mA) in an environment of 40° C., and then discharged at 5 hour rate (300 mA) until the battery voltage becomes 1.0 V. This charge/discharge cycle is repeated 100 times. The ratio of the discharge capacity at the 100th cycle to the discharge capacity at the second cycle is verified as a capacity retention rate in percentage. Table 3 shows the result.

TABLE 3

| | Comparative | | | |
|---|---|---|---|---|
| | example 1 | Example 1 | Example 2 | Example 3 |
| capacity | 67 | 85 | 87 | 89 |
| retention rate | | | | |
| (%) | | | | |

As shown in Table 3, compared with comparative example 1, the capacity retention rate is obviously increased and the life property is improved in examples 1 to 3. The hydrogen-absorbing alloys in examples 1 to 3 are verified to have a capacity that is substantially equivalent to that of an AB₃ type alloy and is higher than that of an AB₅ type alloy by about 10%.

### INDUSTRIAL APPLICABILITY

The hydrogen-absorbing alloy of the present invention can provide alloy powder for an electrode that simultaneously allows a high discharge characteristic and excellent life property (high-temperature life property or the like) of the alkaline storage battery. Therefore, the hydrogen-absorbing alloy is expected to be used as a power source for various apparatuses.

### REFERENCE MARKS IN THE DRAWINGS

1 negative electrode

2 positive electrode

3 separator

4 battery case

6 safety valve

7 seal plate

8 insulating gasket

9 positive electrode lead

1. A hydrogen-absorbing alloy, wherein
an X-ray diffraction image generated by CuKα rays has at least one peak selected from:
(1) a peak Psp1 at 2θ=32.25±0.15°;
(2) a peak Psp2 at 2θ=33.55±0.15°; and
(3) a peak Psp3 at 2θ=37.27±0.15°.

2. The hydrogen-absorbing alloy according to claim 1 having a crystal structure belonging to a space group of P63/mmc.

3. The hydrogen-absorbing alloy according to claim 1, wherein
a ratio I1/Imax of an intensity I1 of the peak Psp1 to an intensity Imax of a maximum peak Pmax of the X-ray diffraction image in a range of 2θ=10 to 90° is 0.01 or more.

4. The hydrogen-absorbing alloy according to claim 1, wherein
a ratio I2/Imax of an intensity I2 of the peak Psp2 to the intensity Imax of the maximum peak Pmax of the X-ray diffraction image in the range of 2θ=10 to 90° is 0.01 or more.

5. The hydrogen-absorbing alloy according to claim 1, wherein
a ratio I3/Imax of an intensity I3 of the peak Psp3 to the intensity Imax of the maximum peak Pmax of the X-ray diffraction image in the range of 2θ=10 to 90° is 0.01 or more.

6. An alloy powder for an electrode, comprising:
the hydrogen-absorbing alloy according to claim 1.

7. The alloy powder for the electrode according to claim 6, wherein
the hydrogen-absorbing alloy includes an element L, an element M, and an element E,
the element L is at least one element selected from a set consisting of elements in group 3 and elements in group 4 on a periodic table,
the element M is an alkaline-earth metal element,
the element E is at least one element selected from a set consisting of: transition metal elements in groups 5 to 11 on the periodic table; elements in group 12; elements in group 13 periods 2 to 5; elements in group 14 periods 3 to 5; N; P; and S, and
a molar ratio mE of the element E to a total of the element L and the element M satisfies 2.5≦mE≦4.5.

8. The alloy powder for the electrode according to claim 7, wherein
a molar ratio x of the element M to the total of the element L and the element M satisfies 0.28≦x≦0.5.

9. The alloy powder for the electrode according to claim 7, wherein
the element L includes at least Y and a lanthanoid element,
the element M includes at least Mg, and
the element E includes at least one element selected from a set consisting of V, Nb, Ta, Cr, Mo, W, Mn, Fe, Co, Ni, Cu, Ag, Zn, B, Al, Ga, In, Si, Ge, Sn, N, and P.

10. The alloy powder for the electrode according to claim 9, wherein
the element E includes at least Co, Ni, and Al,
a molar ratio mNi of Ni to the total of the element L and the element M satisfies 2≦mNi≦3.8,
a molar ratio mCo of Co to the total of the element L and the element M satisfies 0.15≦mCo≦0.75, and
a molar ratio mAl of Al to the total of the element L and the element M satisfies 0.01≦mAl≦0.1.

11. A negative electrode for an alkaline storage battery comprising, as a negative electrode active material:
the hydrogen-absorbing alloy according to claim 1.

12. An alkaline storage battery comprising:
a positive electrode;
a negative electrode;
a separator interposed between the positive electrode and the negative electrode; and
an alkaline electrolytic solution,
wherein the negative electrode includes the negative electrode for the alkaline storage battery according to claim 11.

13. A negative electrode for an alkaline storage battery comprising, as a negative electrode active material:
the alloy powder for the electrode according to claim 6.
